(19) United States
(12) Patent Application Publication
(10) Pub. No.: US 2026/0147367 A1
(43) Pub. Date: May 28, 2026

(54) DUAL-INPUT LOW-DROPOUT VOLTAGE REGULATING CIRCUIT

(71) Applicant: Chengdu Monolithic Power Systems Co., Ltd., Chengdu (CN)

(72) Inventor: Yong Zhou, Chengdu (CN)

(21) Appl. No.: 19/178,244

(22) Filed: Apr. 14, 2025

(30) Foreign Application Priority Data
Apr. 15, 2024 (CN) 202410448513.2

(51) Int. Cl. G05F 1/575

(52) U.S. Cl. CPC G05F 1/575

(57) ABSTRACT

A dual-input low-dropout voltage regulating circuit includes a first input terminal, a second input terminal, a power transistor, and a switching circuit. The first input terminal is configured to receive a first input voltage from a primary power supply. The second input terminal is configured to receive a second input voltage from a backup power supply. The power transistor is configured to convert at least one of the first input voltage and the second input voltage to an output voltage. The switching circuit includes a first switching transistor coupled between the first input terminal and the power transistor, and a second switching transistor and a third switching transistor coupled between the second input terminal and the power transistor. A body diode in the second switching transistor and a body diode in the third switching transistor are coupled in series in a back-to-back manner.

### CROSS-REFERENCE TO RELATED APPLICATIONS

The present application claims priority to, and the benefit of, Chinese application No. 202410448513.2 filed on Apr. 15, 2024, which is incorporated herein by reference in its entirety.

### TECHNICAL FIELD

The present disclosure relates to power regulation, and in particular, but not limited to a dual-input Low-Dropout (LDO) voltage regulating circuit that receives input voltages from two power supplies.

### BACKGROUND

Because of its simple structure, low cost and small static current, LDO voltage regulating circuit is widely used in applications where the output voltage is close to the input voltage.

FIG. 1 is a schematic circuit diagram of an existing LDO voltage regulating circuit, including a power transistor MP, a resistor R1 and a resistor R2, and an error amplifier AMP. The power transistor MP is configured to work in the variable resistance region and to convert an input voltage Vin to an output voltage Vout. The resistors R1 and R2 form a feedback network for providing a feedback voltage Vfb being indicative of the output voltage Vout. The error amplifier AMP is configured to receive the feedback voltage Vfb, amplify a difference between the feedback voltage Vfb and a reference voltage Vref, and generate an amplified signal Va to control the power transistor MP, so as to adjust the output voltage Vout to an expected output voltage indicated by the reference voltage Vref.

With the widespread application of electronic products, users have higher and higher requirements for power supply. Most of the existing LDO products provide input voltage from a single power supply, which will seriously affect the stability of electronic products when the single power supply is damaged or faulty. An existing method is to provide an auxiliary LDO voltage regulating circuit, and the input voltage is provided from two independent power supplies by using two separate LDO voltage regulating circuits. However, this method is inconvenient and expensive.

### SUMMARY

An embodiment of the present disclosure provides a dual-input low-dropout voltage regulating circuit, which includes a first input terminal, a second input terminal, a power transistor, and a switching circuit. The first input terminal is configured to receive a first input voltage. The second input terminal is configured to receive a second input voltage. The power transistor is configured to convert at least one of the first input voltage and the second input voltage to an output voltage. The switching circuit includes a first switching transistor coupled between the first input terminal and the power transistor, and a second switching transistor and a third switching transistor coupled between the second input terminal and the power transistor. A body diode of the second switching transistor and a body diode of the third switching transistor are coupled in series in a back-to-back manner.

According to an embodiment of the present disclosure, the second switching transistor and the third switching transistor each includes a P-channel metal oxide semiconductor field effect transistor.

According to an embodiment of the present disclosure, the dual-input low-dropout voltage regulating circuit further includes a power supply switching control circuit configured to switch the input voltage of the power transistor between the first input voltage and the second input voltage by controlling turn-on and turn-off of the first switching transistor, the second switching transistor and the third switching transistor.

According to an embodiment of the present disclosure, if a primary power supply is designated as a priority power supply, the power supply switching control circuit is configured to: in response to the first input voltage becoming lower than a primary power supply stability threshold, switch the input voltage of the power transistor to the second input voltage; and in response to the first input voltage becoming higher than the primary power supply stability threshold, switch the input voltage of the power transistor to the first input voltage. The first input voltage is received from the primary power supply.

According to an embodiment of the present disclosure, the power supply switching control circuit is configured to: generate a first switching control signal for controlling the turn-on and turn-off of the first switching transistor, a second switching control signal for controlling the turn-on and turn-off of the second switching transistor and a third switching control signal for controlling the turn-on and turn-off of the third switching transistor, based on a primary power supply priority indication signal for indicating whether the primary power supply is designated as the priority power supply and a primary power supply stability indication signal for indicating whether the primary power supply is in a stable state.

According to an embodiment of the present disclosure, when the primary power supply priority indication signal is active, the power supply switching control circuit is configured to: in response to the primary power supply stability indication signal changing from a reset logic state to a set logic state, change the first switching control signal from the set logic state to the reset logic state to turn on the first switching transistor, and change both the second switching control signal and the third switching control signal from the reset logic state to the set logic state to turn off the second switching transistor and the third switching transistor respectively; and in response to the primary power supply stability indication signal changing from the set logic state to the reset logic state, change the first switching control signal from the reset logic state to the set logic state to turn off the first switching transistor, and change the second switching control signal and the third switching control signal from the set logic state to the reset logic state to turn on the second switching transistor and the third switching transistor respectively.

According to an embodiment of the present disclosure, if a primary power supply is not designated as a priority power supply, the power supply switching control circuit is configured to: in response to the first input voltage becoming higher than the second input voltage, switch the input voltage of the power transistor to the first input voltage; and in response to the first input voltage becoming lower than the second input voltage, switch the input voltage of the power transistor to the second input voltage. The first input voltage is received from the primary power supply.

According to an embodiment of the present disclosure, the power supply switching control circuit is configured to: generate a first switching control signal for controlling the turn-on and the turn-off of the first switching transistor, a second switching control signal for controlling the turn-on and turn-off of the second switching transistor, and a third switching control signal for controlling the turn-on and turn-off of the third switching transistor, based on a primary power supply priority indication signal for indicating whether the primary power supply is designated as the priority power supply, the first input voltage and the second input voltage.

According to an embodiment of the present disclosure, when the primary power supply priority indication signal is inactive, the power supply switching control circuit is configured to: in response to the first input voltage becoming higher than the second input voltage, change the first switching control signal from the set logic state to the reset logic state to turn on the first switching transistor, and change both the second switching control signal and the third switching control signal from the reset logic state to the set logic state to turn off the second switching transistor and the third switching transistor respectively; and in response to the first input voltage becoming lower than the second input voltage, change the first switching control signal from the reset logic state to the set logic state to turn off the first switching transistor, and change both the second switching control signal and the third switching control signal from the set logic state to the reset logic state to turn on the second switching transistor and the third switching transistor respectively.

According to an embodiment of the present disclosure, the power supply switching control circuit is configured to: in response to the first input voltage becoming higher than the second input voltage, turn on the first switching transistor and turn off the second switching transistor, and turn off the third switching transistor after a delay period following turning on the first switching transistor and turning off the second switching transistor, to switch the input voltage of the power transistor to the first input voltage; and in response to the first input voltage becoming lower than the second input voltage, turn off the first switching transistor and turn on the second switching transistor to switch the input voltage of the power transistor to the second input voltage, wherein the third switching transistor is turned on by an advance period before turning off the first switching transistor and turning on the second switching transistor.

According to an embodiment of the present disclosure, the switching control signal generating circuit is configured to: generate a first switching control signal for controlling the turn-on and turn-off of the first switching transistor, a second switching control signal for controlling the turn-on and turn-off of the second switching transistor, and a third switching control signal for controlling the turn-on and turn-off of the third switching transistor, based on a primary power supply priority indication signal for indicating whether the primary power supply is designated as priority power supply, a primary power supply stability indication signal for indicating whether the primary power supply is in a stable state, the first input voltage, and the second input voltage.

According to an embodiment of the present disclosure, wherein when the primary power supply priority indication signal is inactive, the switching control signal generating circuit is configured to: change the first switching control signal from a set logic state to a reset logic state to turn on the first switching transistor, and change the second switching control signal from the reset logic state to the set logic state to turn off the second switching transistor in response to the first input voltage becoming higher than the second input voltage, and change the third switching control signal from the reset logic state to the set logic state to turn off the third switching transistor in response to the primary power supply stability indication signal changing from the reset logic state to the set logic state; and change the third switching control signal from the set logic state to the reset logic state to turn on the third switching transistor in response to the primary power supply stability indication signal changing from the set logic state to the reset logic state, and change the first switching control signal from the reset logic state to the set logic state to turn off the first switching transistor and change the second switching control signal from the set logic state to the reset logic state to turn on the second switching transistor in response to the first input voltage becoming lower than the second input voltage.

According to an embodiment of the present disclosure, the power supply switching control circuit includes a register for storing information indicating whether the primary power supply priority indication signal is active or not.

According to an embodiment of the present disclosure, the power supply switching control circuit further includes a primary power supply state determination circuit, configured to determine whether the primary power supply is in the stable state.

According to an embodiment of the present disclosure, the primary power supply state determination circuit is configured to determine that the primary power supply is in the stable state when the first input voltage is higher than the primary power supply stability threshold; and determine that the primary power supply is not in the stable state when the first input voltage is lower than the primary power supply stability threshold.

Another embodiment of the present disclosure provides a power management chip, which includes the aforementioned dual-input low-dropout voltage regulating circuit.

The dual-input LDO voltage regulating circuit according to the present disclosure effectively prevents current leakage paths through body diodes when operating under the condition where the primary power supply provides input voltage, and the backup power supply remains in a standby mode. Specifically, the backup power supply is blocked from forming current supply paths via the body diode of the second switching transistor and the body diode of the third switching transistor. This configuration reliably eliminates voltage or current leakage from the backup power supply to both the primary power supply and the output terminal, thereby ensuring continuous and stable output voltage delivery to the load by the dual-input LDO voltage regulating circuit.

### BRIEF DESCRIPTION OF DRAWINGS

The purpose, specific structural features and advantages of the present disclosure can be further understood by describing some embodiments of the present disclosure and the attached drawings.

FIG. 1 shows a schematic circuit diagram of an existing LDO voltage regulating circuit.

FIG. 2 shows a schematic circuit diagram of a dual-input LDO voltage regulating circuit 200, according to an embodiment of the present disclosure.

FIGS. 3a and 3b illustrate exemplary relationship diagrams between the first input voltage provided by the first power supply and the second input voltage provided by the second power supply, according to an embodiment of the present disclosure.

FIG. 4 shows a schematic circuit diagram of a switching control signal generating circuit, according to an embodiment of the present disclosure.

FIG. 5 shows a schematic circuit diagram of a dual-input LDO voltage regulating circuit, according to another embodiment of the present disclosure.

FIG. 6 shows a schematic circuit diagram of a switching control signal generating circuit, according to another embodiment of the present disclosure.

FIG. 7 shows a waveform diagram 700 of the switching control signals g1, g1, and g3 and the first input voltage Vin1, according to an embodiment of the present disclosure.

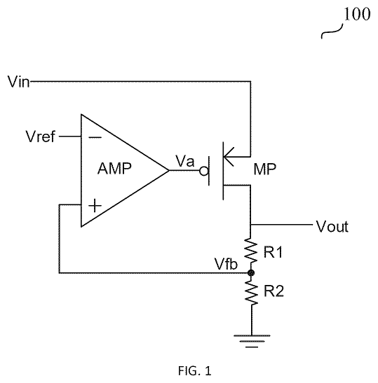

The same reference numerals in different schematic drawings indicate the same or similar parts or features.

### DETAILED DESCRIPTION OF THE PRESENT APPLICATION

Hereinafter, specific embodiments of the present application will be described in detail, and it should be noted that the embodiments described here are only for illustration and are not used to limit the present application. In the following description, some specific details are included to provide a thorough understanding of embodiments. One skilled in the relevant art will identify, however, that the present application can be practiced without one or more specific details. In other instances, well-known structures, materials, processes or operations are not shown or described in detail to avoid obscuring aspects of the present application.

Throughout the specification and claims, the phrases “in an embodiment”, “in some embodiments”, “in one implementation”, and “in some implementations” as used includes both combinations and sub-combinations of various features described herein as well as variations and modifications thereof. These phrases used herein does not necessarily refer to the same embodiment, although it may. Those skilled in the art should understand that the meanings of the terms identified above do not necessarily limit the terms, but merely provide illustrative examples for the terms. It is noted that when an element is “connected to” or “coupled to” the other element, it means that the element is directly connected to or coupled to the other element or indirectly connected to or coupled to the other element via another element. Particular features, structures or characteristics may be included in an integrated circuit, an electronic circuit, a combinational logic circuit, or other suitable components that provide the described functionality. In addition, it is appreciated that the figures provided herewith are for explanation purposes to persons ordinarily skilled in the art and that the drawings are not necessarily drawn to scale.

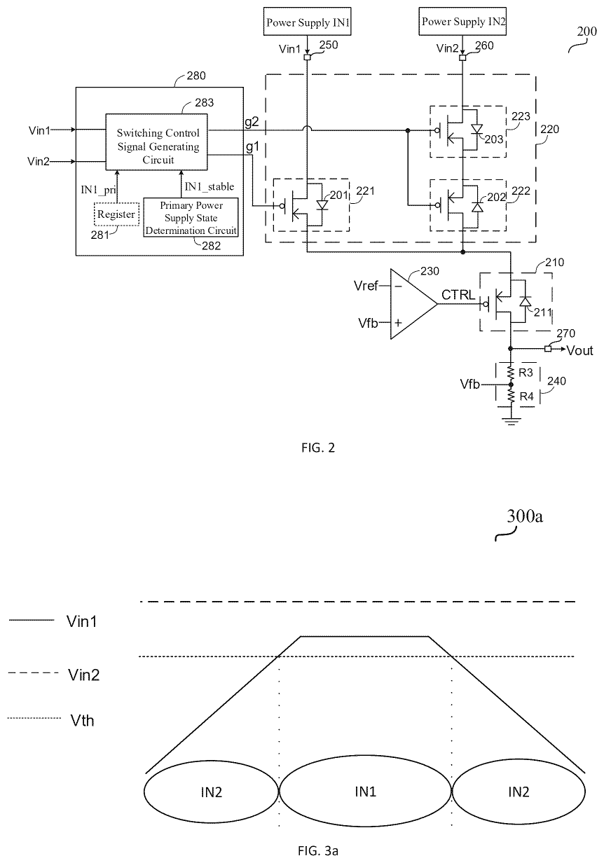

FIG. 2 shows a schematic circuit diagram of a dual-input LDO voltage regulating circuit 200, according to an embodiment of the present disclosure. The dual-input LDO voltage regulating circuit 200 can be applied to any suitable implementation, for example, it can be applied to a power management integrated circuit (PMIC).

As shown in FIG. 2, the dual-input LDO voltage regulating circuit 200 includes a power transistor 210, a switching circuit 220, an error amplifier 230, a feedback circuit 240, a first input terminal 250, a second input terminal 260 and an output terminal 270.

In an embodiment, the dual-input LDO voltage regulating circuit 200 may be provided with input voltage by a first power supply IN1 and/or a second power supply IN2. As shown in FIG. 2, in an embodiment, the dual-input LDO voltage regulating circuit 200 may receive a first input voltage Vin1 from the first power supply IN1 through the first input terminal 250 and/or a second input voltage Vin2 from the second power supply IN2 through the second input terminal 260. In practical application scenarios, when employing dual power supplies to power a dual-input LDO configuration, one power supply is conventionally designated as the primary power supply while the other is designated as the backup power supply. For example, in an application example of the PMIC, the primary power supply can be a pre-stage converter, and the backup power supply can be a battery located outside the PMIC. Under normal operational conditions where the primary power supply maintains a stable voltage output, the system utilizes the primary power supply for voltage regulation while maintaining the backup power supply in a standby mode. Upon detection of primary power supply failure or voltage degradation-for example, when the first input voltage from the primary power supply falls below a predefined primary power supply stability threshold Vth-the system automatically initiates a seamless transition to the backup power supply. The embodiments of the present disclosure are described by taking the exemplary configuration where the first power supply IN1 serves as the primary power supply and IN2 functions as the backup power supply.

In an embodiment, the switching circuit 220 may be used to selectively conduct a current path(s) between the power transistor 210 and one of or both the first power supply IN1 and the second power supply IN2, so that at least one of the first input voltage Vin1 or the second input voltage Vin2 is provided to the power transistor 210. In an embodiment, the switching circuit 220 includes switching transistors 221-223. The switching transistor 221 is coupled between the first input terminal 250 and the power transistor 210, and the switching transistor 222 and the switching transistor 223 are coupled in series between the second input terminal 260 and the power transistor 210. In an embodiment, the switching transistors 221-223 each include a body diode, i.e., body diodes 201-203. In an embodiment, the body diode 202 of the switching transistor 222 and the body diode 203 of the switching transistor 223 are coupled in series in a back-to-back manner, i.e., an anode of one of the diodes 202 and 203 is connected to a cathode of the other one of the diodes 202 and 203. In this way, when the first power supply IN1 supplies input voltage (e.g., the first input voltage Vin1) to the power transistor 210 (at this time, the switching transistor 201 is turned on, and the switching transistors 222 and 223 are turned off), the body diode 202 and the body diode 203 will not be forward-biased/turned on at the same time due to the back-to-back manner. Therefore, under a condition where the first power supply IN1 supplies the input voltage and the second power supply IN2 is in the standby mode, the second power supply IN2 is prevented from establishing a current path through body diodes 202 and 203, thus avoiding current/voltage leakage from the second power supply IN2 to the first power supply IN1 and an output terminal 270, and ensuring that the dual-input LDO voltage regulating circuit 200 delivers continuous and stable output voltage Vout to the load. For example, in an exemplary embodiment where the switching transistors 222 and 223 are P-channel metal oxide semiconductor field effect transistors (PMOSFET), the two PMOSFET are connected in a common source manner, so that the body diode 202 and the body diode 203 are coupled in series in the back-to-back manner. For example, as shown in the embodiment of FIG. 2, the drain of the switching transistor 223 is coupled to the second input terminal 260, the source of the switching transistor 223 is coupled to the source of the switching transistor 222, and the drain of the switching transistor 223 is coupled to the power switch 210, so that the body diode 202 and the body diode 203 are coupled in series in the back-to-back manner. The two PMOSFET can also be connected in a common drain mode, and the present disclosure can design corresponding driving circuits and related logic control circuits for the change of back-to-back connection form. The present disclosure is not limited thereto.

In an embodiment, the power transistor 210 receives at least one of the first input voltage Vin1 and the second input voltage Vin2 through the switching circuit 220 and convert the received input voltage(s) in the output voltage Vout. According to working principles of LDO voltage regulator, when the power transistor 210 works in the variable resistance region, it's resistance can be dynamically controlled by adjusting a control signal CTRL applied to a control terminal of the power transistor 210, so that the output voltage Vout can be adjusted to the expected output voltage. In an embodiment, the power transistor 210 can be implemented with a power FET. For example, the power transistor 210 may include a PMOSFET. In an embodiment, the power transistor 210 includes a body diode 211. In an embodiment, a cathode of the body diode 211 is facing upwards and the anode is facing downwards to avoid current or voltage leakage from the first power supply IN1 or the second power supply IN2 to the output terminal 270. In other embodiments, the power transistor 210 may also include other types of transistors, such as NMOSFET.

In an embodiment, the feedback circuit 240 is configured to provide a feedback signal Vfb being indicative of the output voltage Vout. In the embodiment shown in FIG. 2, the feedback circuit 240 includes resistors R3 and R4, and the voltage Vfb fed back by the feedback circuit 240 is a portion of the output voltage Vout.

In an embodiment, the error amplifier 230 has a first input terminal (e.g., an inverting input terminal) and a second input terminal (e.g., a noninverting input terminal). The first input terminal is configured to receive a reference voltage Vref being indicative of the expected output voltage, and the second input terminal is configured to receive the feedback signal Vfb. The error amplifier 230 is configured to compare the feedback signal Vfb with the reference voltage Vref to generate the control signal CTRL for controlling the power transistor 210. For example, if the feedback voltage Vfb is higher than the reference voltage Vref, the error amplifier 230 will adjust the control signal CTRL to control and reduce a current flowing through the power transistor 210, so as to reduce the output voltage Vout. If the feedback voltage Vfb is lower than the reference voltage Vref, the error amplifier 230 will adjust the control signal CTRL to control and increase the current flowing through the power transistor 210, so as to increase the output voltage Vout.

In an embodiment, the dual-input LDO voltage regulating circuit 200 may further include a power supply switching control circuit 280, configured to control the turn-on and turn-off of the switching transistors 221-223 to switch the input voltage of the power transistor 210. For example, as shown in FIG. 2, the power supply switching control circuit 280 may include a switching control signal generating circuit 283, configured to generate a first switching control signal g1 for controlling the switching transistor 221 and a second switching control signal g2 for controlling the switching transistors 222 and 223. In an embodiment, the first switching control signal g1 is used to control the turn-on and turn-off of the switching transistor 221, and the second switching control signal g2 is used to control the turn-on and turn-off of the switching transistor 222 and the switching transistor 223. For example, when the first power supply IN1 is selected as the input voltage supply, the power supply switching control circuit 280 utilizes the first switching control signal g1 to turn on the switching transistor 221 while turning off the switching transistors 222 and 223 via the second switching control signal g2, thereby supplying the first input voltage Vin1 to the power transistor 210. Conversely, when the second power supply IN2 is selected as the input voltage supply, the power supply switching control circuit 280 utilizes the first switching control signal g1 to turn off the switching transistor 221 while turning on the switching transistors 222 and 223 via the second switching control signal g2, thus delivering the second input voltage Vin2 to the power transistor 210.

As previously described, when the first power supply IN1 (i.e., the primary power supply) is in a stable state (e.g., the input voltage from the first power supply IN1 is above the primary power supply stability threshold Vth), the system typically utilizes the first power supply IN1 as the input voltage source while keeping the second power supply IN2 (i.e., the backup power supply) in a standby mode. Upon detection of a fault or power loss in the first power supply IN1 (e.g., the input voltage from the first power supply IN1 drops below the primary power supply stability threshold Vth), the system initiates a transition to the second power supply IN2 to provide input voltage to the power transistor 210.

According to an embodiment of the present disclosure, as shown in FIG. 2, the power supply switching control circuit 280 may include a primary power supply state determination circuit 282, configured to determine whether the primary power supply (e.g., the first power supply IN1) is in the stable state and output a primary power supply stability indication signal IN1_stable for indicating whether the primary power supply is in the stable state. For example, when it is determined that the primary power supply is in the stable state, the primary power supply state determination circuit 282 may set the primary power supply stability indication signal IN1_stable to a set logic state (e.g., logic high), and when it is determined that the first power supply IN1 is not in the stable state, the primary power supply state determination circuit 282 may set the primary power supply stability indication signal IN1_stable to a reset logic state (e.g., logic low). In an embodiment, when the voltage (e.g., the first input voltage Vin1) provided by the primary power supply (e.g., the first power supply IN1) is higher than the primary power supply stability threshold Vth, the primary power supply state determination circuit 282 may determine that the first power supply IN1 is in the stable state, and when it is lower than the primary power supply stability threshold Vth, the primary power supply state determination circuit 282 may determine that the first power supply IN1 is not in the stable state. The present disclosure is not limited to this. For example, the primary power supply state determination circuit 282 may determine that the primary power supply (for example, the first power supply IN1) is not in the stable state if the voltage value (for example, the first input voltage Vin1) of the primary power supply (for example) is lower than the primary power supply stability threshold Vth for a predetermined period. The primary power supply stability threshold Vth may be a certain percentage (for example, 80%) of the target voltage value of the first power supply IN1.

In an embodiment, the power supply switching control circuit 280 may further include a backup power supply effectiveness determination circuit (not shown), configured to determine whether the backup power supply (e.g., the second power supply IN2) is effective, and output a backup power supply effectiveness indication signal IN2_OK indicating the effectiveness status of said backup power supply. In an embodiment, when the second power supply IN2 is determined to be effective, the backup power supply effectiveness determination circuit may set the backup power supply effectiveness indication signal IN2_OK to the set logic state (e.g., logic high), and when the second power supply IN2 is determined to be ineffective, the backup power supply effectiveness determination circuit may set the backup power supply effectiveness indication signal IN2_OK to a reset logic state (e.g., logic low). In an embodiment, when the backup power supply is determined to be ineffective, switching operation between the primary power supply and the backup power supply is not performed. The switching between the primary power supply and the backup power supply discussed below is based on the premise that the backup power supply is effective.

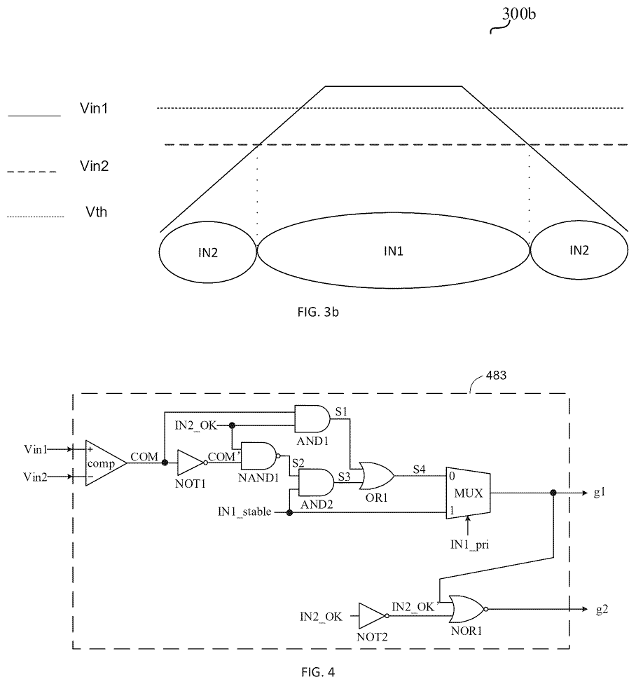

According to the embodiment of the application, under which circumstance switching between the primary and backup power supplies is required are typically determined based on the voltage relationship between the two power supplies. FIGS. 3a and 3b show exemplary relationship diagrams 300a and 300b between the first input voltage Vin1 provided by the first power supply IN1 and the second input voltage Vin2 provided by the second power supply IN2, according to an embodiment of the present disclosure.

FIG. 3a shows a situation where the second input voltage Vin2 is higher than the primary power supply stability threshold Vth. In this situation, when the first input voltage Vin is higher than the primary power supply stability threshold Vth (i.e., the first power supply IN1 is in the stable state), the first power supply IN1 is selected to provide the input voltage for the voltage regulator 200. When the first power supply IN1 loses power and the first input voltage Vin1 drops/falls below the primary power supply stability threshold Vth (i.e., the first power supply IN1 is not in the stable state), it is switched to the second power supply IN2 to provide power for the voltage regulator 200. For the relationship shown in FIG. 3a, since the second input voltage Vin2 is relatively higher than the first input voltage Vin1, the first power supply IN1 needed be configured with higher priority to serve as the primary power supply to prioritize power delivery from IN1 over IN2. According to an embodiment of the present disclosure, a primary power supply priority indication signal IN1_pri may be used to indicate whether the first power supply IN1 is set to provide power preferentially even when the first input voltage Vin1 is lower than second input voltage Vin2. For example, when the primary power supply priority indication signal IN1_pri is set to the set logic state (e.g., logic high), it indicates that the first power supply IN1 is designated as the priority power supply, and when the primary power supply priority indication signal IN1_pri is set to the second logic state (e.g., logic low), it indicates that the first power supply IN1 is not designated as the priority power supply. For example, the power supply switching control circuit 280 is configured to determine whether to set the first power supply IN1 as the priority power supply based on the magnitude relationship between the primary power supply stability threshold Vth of the first power supply IN1 and the second input voltage Vin2. The present disclosure is not limited to this. For example, the user can set the priority of the first power supply IN1 in advance based on the preset target voltage values of the first power supply IN1 and the second power supply IN2. According to an embodiment of the present disclosure, the power supply switching control circuit 280 may further include a register (shown as a dashed line box 281 in FIG. 2) for storing information for indicating whether the primary power supply priority indication signal IN1_pri is active (e.g., logic high), for example, the information may be pre-stored in the register during system initialization.

FIG. 3b shows a situation where the second input voltage Vin2 provided by the second power supply Vin2 is lower than the primary power supply stability threshold Vth. The exemplary embodiment shown in FIG. 3b is applicable to the situation where the first input voltage Vin1 is relatively high (for example, relative to the second input voltage Vin2 and the output voltage). Therefore, even when the first power supply IN1 experiences power loss causing the first input voltage Vin1 to drop below the primary power supply stability threshold Vth, the voltage differential between the first input voltage Vin1 and the output voltage Vout remains greater than the dropout voltage of the power transistor 210. This means that while the first input power supply IN1 has technically entered a power-deficient state, it can still maintain input voltage supply until the first input voltage Vin1 falls below the second input voltage Vin2, at which point the system transitions to the second power supply IN2. In this way, this approach enables a smoother transition/switching between the two power supplies.

Referring back to FIG. 2, in an embodiment, when the magnitude relationship between the first input voltage Vin1 and the second input voltage Vin2 satisfies, for example, the relationship shown in FIG. 3a, the first power supply IN1 can be designated as the priority supply (for example, the primary power supply priority indication signal IN1_pri is active (e.g., logic high). The power switching control circuit 280 is configured to: switch the input voltage of power transistor 210 to the second input voltage Vin2 in response to the primary power supply stability indication signal IN1_stable changing to the reset logic state (e.g., logic low); and switch the input voltage of power transistor 210 to the first input voltage Vin1 in response to the primary power supply stability indication signal IN1_stable changing to the set logic state (e.g., logic high). In an embodiment, the power supply switching control circuit 280 (or the switching control signal generating circuit 283 therein) is configured to generate switching control signals g1 and g2 for controlling the switching transistors 221-223 based on the primary power supply priority indication signal IN1_pri and the primary power supply stability indication signal IN1_stable. In an embodiment, under the condition where the primary power supply priority indication signal IN1_pri is active (e.g., logic high), the power supply switching control circuit 280 (or the switching control signal generating circuit 283 therein): in response to the primary power supply stability indication signal IN1_stable changing from the reset logic state (e.g., logic low) to the set logic state (e.g., logic high), change the first switching control signal g1 from the set logic state (e.g., logic high) to the reset logic state (e.g., logic low) to turn on the switching transistor 221 and change the second switching control signal g2 from the reset logic state (e.g., logic low) to the set logic state (e.g., logic high) to turn off the switching transistors 222 and 223; and in response to the primary power supply stability indication signal IN1_stable changing from the set logic state (e.g., logic high) to the reset logic state (e.g., logic low), change the first switching control signal g1 from the reset logic state (e.g., logic low) to the set logic state (e.g., logic high) to turn off the switching transistor 221 and change the second switching control signal g2 from the reset logic state (e.g. logic low) to the set logic state (e.g. logic high) to turn on the switching transistors 222 and 223.

In an embodiment, under the condition where the magnitude relationship between the first input voltage Vin1 and the second input voltage Vin2 satisfies, for example, the magnitude relationship shown in FIG. 3b, the first power supply IN1 is not specifically configured as the priority power supply (for example, the primary power supply priority indication signal IN1_pri is inactive (e.g., logic low)), and the power supply switching control circuit 280(or the switching control signal generating circuit 283 therein) is configured to switch the input voltage of the power transistor 210 based on the magnitude relationship between the first input voltage Vin1 and the second input voltage Vin2. For example, the power supply switching control circuit 280 (or the switching control signal generating circuit 283 therein) is configured to switch the input voltage of the power transistor 210 to the first input voltage Vin1 in response to the first input voltage Vin1 becoming higher than the second input voltage Vin2; and switch the input voltage of the power transistor 210 to the second input voltage Vin2 in response to the first input voltage Vin1 becoming lower than the second input voltage Vin2. In an embodiment, the power supply switching control circuit 280 (or the switching control signal generating circuit 283 therein) is configured to generate the switching control signals g1 and g2 based on the first input voltage Vin1 and the second input voltage Vin2. In an embodiment, under the condition where the primary power supply priority indication signal IN1_pri is inactive (e.g., logic low), the switching control signal generating circuit 283 is configured to: in response to the first input voltage Vin1 becoming higher than the second input voltage Vin2, change the first switching control signal g1 from the set logic state (e.g., logic high) to the reset logic state (e.g., logic low) to turn on the switching transistor 221 and changes the second switching control signal g2 from the reset logic state (e.g., logic low) to the set logic state (e.g., logic high) to turn off the switching transistors 222 and 223; and in response to the first input voltage Vin1 becoming lower than the second input voltage Vin2, change the first switching control signal g1 from the reset logic state (e.g., logic low) to the set logic state (e.g., logic high) to turn off the switching transistor 221, and change the second switching control signal g2 from the set logic state (e.g., logic high) to the reset logic state (e.g., logic low) to turn on the switching transistors 222 and 223.

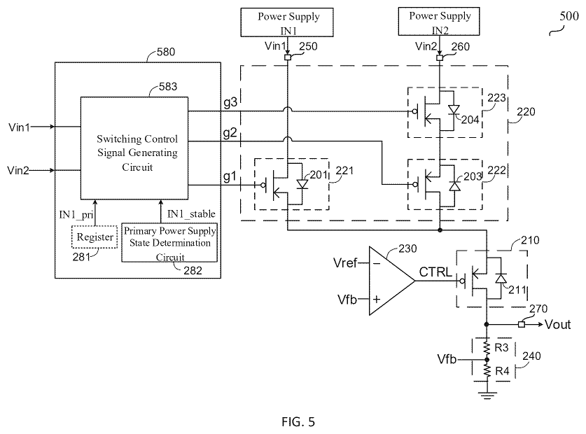

FIG. 4 shows a schematic circuit diagram of a switching control signal generating circuit 483, according to an embodiment of the present disclosure. The switching control signal generating circuit 483 is a specific embodiment of the switching control signal generating circuit 283 shown in FIG. 2. FIG. 4 will be described in conjunction with FIGS. 2, 3a and 3b.

As shown in FIG. 4, the switching control signal generating circuit 483 includes a comparator comp, a first inverter NOT1, a second inverter NOT2, a first NAND gate NAND1, a first AND gate AND1, a second AND gate AND2, a first OR gate OR1, a first NOR gate NOR1, and a selector MUX. The comparator comp is configured to compare the first input voltage Vin1 with the second input voltage Vin2 to generate a comparison signal COM. The first AND gate AND1 is configured to receive the comparison signal COM on a first input terminal, and receive the backup power supply effectiveness indication signal IN2_OK on a second input terminal, and generate a first logic signal S1 on an output terminal. The first NAND gate NAND1 is configured to receive the backup power supply effectiveness indication signal IN2_OK on a first input terminal, and receive an inverted comparison signal COM′ from the first inverter NOT1 on a second input terminal, and generate a second logic signal S2 on an output terminal. The second AND gate AND2 is configured to receive the second logic signal S2 and the primary power supply stability indication signal IN1_stable, and output a third logic signal S3. The first OR gate OR1 is configured to receive the first logic signal S1 and the third logic signal S3, and output a fourth logic signal S4. The selector MUX is configured to receive the fourth logic signal S4 on a first input terminal and receive the primary power supply stability indication signal IN1_stable on a second input terminal, and receive the primary power supply priority indication signal IN1_pri on a control terminal, and output the first switching control signal g1 on an output terminal. The first NOR gate NOR1 is configured to receive the first switching control signal g1 and the inverted backup power supply effectiveness indication signal IN2_OK′, and output the second switching control signal g2.

As shown in FIG. 4, if the primary power supply is designated as the priority power supply (that is, if the primary power supply priority indication signal IN1_pri is active (e.g., logic high)), if the first power supply IN1 is in the stable state (that is, if the primary power supply stability indication signal IN1_stable is active (e.g., logic high)), the first power supply IN1 is selected to provide the input voltage, and if the first power supply IN1 is not in the stable state (that is, if the primary power supply stability indication signal IN1_stable is inactive (e.g., logic high)), the second power supply IN2 is selected to provide the input voltage. This means that in the case where the first power supply IN1 is designated as the priority power supply, if the first power supply IN1 is in the stable state, the system continues to utilize the first power supply IN1 for input voltage supply even if the first input voltage Vin1 becomes lower than the second input voltage Vin2. In the case where the first power supply IN1 is not designated as the priority power supply (that is, when the primary power supply priority indication signal IN1_pri is inactive (e.g., logic low)), a higher voltage between the first power supply IN1 and the second power supply IN2 is selected for input voltage supply. Specifically, if the first input voltage Vin1 exceeds the second input voltage Vin2, the first power supply IN1 is selected to provide the input voltage; whereas if first input voltage Vin1 is less than the second input voltage Vin2, the second power supply IN2 is selected to provide the input voltage.

As previously described, when the first input voltage Vin1 and the second input voltage Vin2 exhibit an exemplary relationship as illustrated in FIG. 3b, the first power supply IN1 provides the first input voltage Vin1 (e.g., relative to the output voltage Vout) at a level such that even when the first input voltage Vin1 drops below the primary power supply stability threshold Vth, it remains capable of sustaining input supply. Furthermore, the system can await the condition where first input voltage Vin1 falls below the second input voltage Vin2 before transitioning to the second power supply IN2 for input voltage supply to the voltage regulator 200. This approach enables a smoother transition between the two power sources.

However, during the power supply switching process (for example, when the power supply switching control circuit 280 (or the switching control signal generating circuit 283 included therein) changes the first switching control signal g1 from the reset logic state (e.g., logic low) to the set logic state (e.g., logic high) to turn off the switching transistor 221, while transitioning the second switching control signal g2 from the set logic state (e.g., logic high) to the reset logic state (e.g.) to turn on the switching transistors 222 and 223), due to the existence of dead time and turn-on delays of the switching transistor, significant voltage droop will occurs on the output voltage Vout. To mitigate such voltage droop magnitude under such conditions, the embodiments of the present disclosure further propose an improved dual-input LDO voltage regulating circuit.

FIG. 5 shows a schematic circuit diagram of a dual-input LDO voltage regulating circuit 500, according to another embodiment of the present disclosure. The dual-input LDO voltage regulating circuit 500 shown in FIG. 5 can be regarded as a variation of the dual-input LDO voltage regulating circuit 200 shown in FIG. 2. The difference between the dual-input LDO voltage regulating circuit 200 and the dual-input LDO voltage regulating circuit 500 is that the switching transistor 222 and the switching transistor 223 on the current path between the second input terminal 260 and the power transistor 210 are not controlled by the same switching control signal g2 at the same time, but are controlled by two different switching control signals g2 and g3 respectively. That is, the power supply switching control circuit 580 is configured to generate a third switching control signal g3 for controlling the switching transistor 223 in addition to the first switching control signal g1 and the second switching control signal g2. For the sake of simplicity, similar parts of the dual-input LDO voltage regulating circuit 500 and the dual-input LDO voltage regulating circuit 200 will not repeated here.

In the embodiment shown in FIG. 5, the power supply switching control circuit 580 (or the switching control signal generating circuit 583 included therein) is configured to change the third switching control signal g3 to the reset logic state (e.g., logic low) to turn on the switching transistor 223 by an advance period before changing the first switching control signal g1 to the set logic state (e.g., logic high) to turn off the switching transistor 221 and simultaneously changing the second switching control signal g2 to the reset logic state (e.g., logic low) to turn on the switching transistor 222. The power supply switching control circuit 580 (or the switching control signal generating circuit 583 included therein) is further configured to maintain the third switching control signal g3 at the reset logic state until after a specified delay period following the changes of the first switching control signal g1 to the reset logic state (e.g., logic low) to turn on the first switching transistor 221 and changing the second switching control signal g2 to the set logic state (e.g., logic high) to turn off switching transistor 222, thereby delaying the turned-off of switching transistor 223.

Referring back to FIG. 3b, in the process that, for example, the first input voltage Vin1 rises from being lower than the second input voltage Vin2, the switching control signal generating circuit 583 is configured to: in response to the first input voltage Vin1 becoming higher than the second input voltage Vin2, change the first switching control signal g1 from the set logic state (e.g., logic high) to the reset logic state (e.g., logic low) to turn on the switching transistor 221, and simultaneously change the second switching control signal g2 from the reset logic state (e.g., logic low) to the set logic state (e.g., logic high) to turn off the switching transistor 222; and then in response to the primary power supply stability indication signal IN1_stable changing from the reset logic state (e.g., logic low) to the set logic state (e.g., logic high) such as when the first input voltage Vin1 becomes higher than the primary power supply stability threshold Vth, change the third switching control signal g3 from the reset logic state (e.g., logic low) to the set logic state (e.g., logic high) to turn off the switching transistor 223.

On the other hand, during the descent process of the first input voltage Vin1 (e.g., power loss of the first power source VIN1) from higher than the primary power supply stability threshold Vth, the switch control signal generation circuit 583 is configured to: in response to the primary power supply stability indication signal IN1_stable changing from the set logic state (e.g., logic high) to the reset logic state (e.g., logic low), such as when the first input voltage Vin1 falls below the primary power supply stability threshold Vth, change the third switching control signal g3 from the set logic state (e.g., logic high) to the reset logic state (e.g., logic low) to turn on the switching transistor 223; and then in response to the first input voltage Vin1 becoming lower than the second input voltage Vin2, change the first switching control signal g1 from the reset logic state (e.g., logic low) to the set logic state (e.g., logic high) to turn off the switching transistor 221, and change the second switching control signal g2 from the set logic state (e.g., logic high) to the reset logic state (e.g., logic low) to turn on the switching transistor 222.

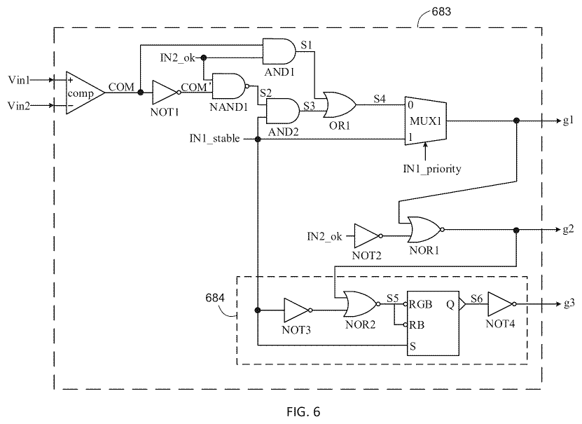

FIG. 6 shows a schematic circuit diagram of a switching control signal generating circuit 683, according to another embodiment of the present disclosure. The switching control signal generating circuit 683 is a specific embodiment of the switching control signal generating circuit 583 shown in FIG. 5.

As shown in FIG. 6, the switching control signal generating circuit 683 is different from the switching control signal generating circuit 483 in that the switching control signal generating circuit 683 further includes a logic sub-circuit 684 for generating the third switching control signal g3. For the sake of brevity, the parts in the switching control signal generating circuit 683 that are similar to those in the switching control signal generating circuit 483 (for example, the parts that generate the first switching control signal g1 and the second switching control signal g2) will not be described again.

As shown in FIG. 6, the logic sub-circuit 684 includes a third inverter NOT3, a fourth inverter NOT4, a second NOR gate NOR2 and an RS flip-flop. The second NOR gate NOR2 is configured to receive the second switching control signal g2 and the inverted version of the primary power supply stability indication signal IN1_stable, and output a logic signal S5. RGB and RB terminals of the RS flip-flop are configured to receive the logic signal S5, a S terminal of the RS flip-flop is configured to receive the primary power supply stability indication signal IN1_stable, and a Q terminal of the RS flip-flop is configured to output a logic signal S6, which is then inverted by the inverter NOT4 to generate the third switching control signal g3.

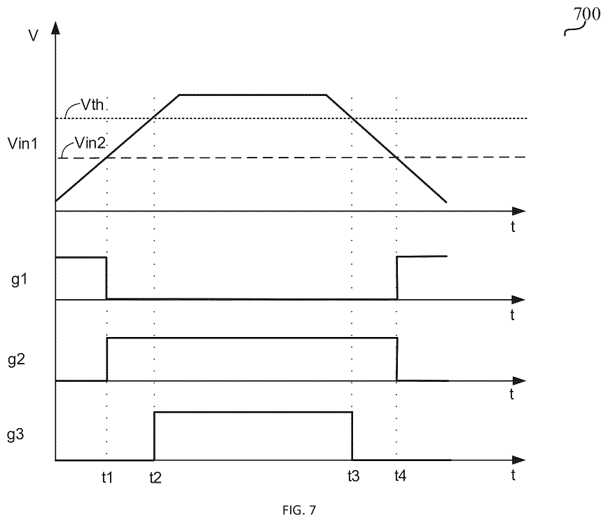

FIG. 7 shows a waveform diagram 700 of the switching control signals g1, g1, and g3 and the first input voltage Vin1, according to an embodiment of the present disclosure. FIG. 7 will be described with reference to FIGS. 3b, 5 and 6.

As shown in FIG. 7, prior to time t1, the first input voltage Vin1 supplied by the first power supply IN1 remains lower than the second input voltage Vin2 supplied by the second power supply IN2. During this period, the first switching control signal g1 is maintained at logic high, the second switching control signal g2 and the third switching control signal g3 are maintained at logic low, and it is the second power supply IN2 that provide power to the dual-input LDO voltage regulating circuit 500. When the first input voltage Vin1 gradually increases and surpasses the second input voltage Vin2 at time t1, the switching control signal generating circuit 583 (or 683) changes the first switching control signal g1 to logic low to turn on the switching transistor 221, changes the second switching control signal g2 to logic high to turn off the switching transistor 222, and maintains the third switching control signal g3 at logic low to keep the switching transistor 223 conductive. At this time (i.e., time t1), the input voltage of the dual-input LDO voltage regulating circuit 500 is switched from the second input voltage Vin2 to the first input voltage Vin1. During this power switching process, due to the existence of dead time and the turn-on delay of the switching transistor, a voltage droop occurs at the output voltage Vout. However, by delaying the turn-off of the switching transistor 223, the second power supply IN2 can continue to supply power through the switching transistor 223 and the body diode 202 of the switching transistor 222, thereby mitigating the voltage drop magnitude and achieving a smoother output voltage transition. Subsequently, the second input voltage Vin1 continues to rise and becomes higher than the primary power supply stability threshold Vth at time t2. At this time, the switching control signal generating circuit 583 (or 683) changes the third switching control signal g3 to logic high to turn off the switching transistor 223, so as to completely disconnect the output terminal 270 from the second power supply IN2. The first power supply IN1 is in the stable state between time t2 and time t3, and continuously provides the input voltage to the dual-input LDO voltage regulating circuit. Until time t3, the first input voltage Vin becomes lower than the primary power supply stability threshold Vth, indicating that the first power supply IN1 starts to lose power. At this time, the switching control signal generating circuit 583 changes the switching control signal g3 to logic low in advance to turn on the switching transistor 223, in preparation for switching to the second power supply IN2. Until time t4, when the first input voltage Vin continues to drop below the second input voltage Vin2, the switching control signal generating circuit 583 changes the first switching control signal g1 to logic high to turn off the switching transistor 221, and changes the second switching control signal g2 to logic low to turn on the switching transistor 222. Since the switching transistor 223 has been turned on in advance at the time t3, the dead time and the turn-on delay of the switching transistor in the power supply switching process at the time t4 can be reduced, thereby alleviating the sudden drop of the output voltage during the switching process.

Although some embodiments of the present disclosure have been described in detail above, it should be understood that these embodiments are only for illustrative purposes and are not used to limit the scope of the present disclosure. Other feasible alternative embodiments can be known to those of ordinary skill in the art by reading this disclosure.

1. A dual-input low-dropout voltage regulating circuit, comprising:
a first input terminal, configured to receive a first input voltage;
a second input terminal, configured to receive a second input voltage;
a power transistor, configured to convert at least one of the first input voltage and the second input voltage to an output voltage; and
a switching circuit, comprising a first switching transistor coupled between the first input terminal and the power transistor, and a second switching transistor and a third switching transistor coupled in series between the second input terminal and the power transistor, wherein, a body diode of the second switching transistor and a body diode of the third switching transistor are coupled in series in a back-to-back manner.

2. The dual-input low-dropout voltage regulating circuit according to claim 1, wherein the second switching transistor and the third switching transistor each comprises a P-channel metal oxide semiconductor field effect transistor.

3. The dual-input low-dropout voltage regulating circuit according to claim 1, further comprising: a power supply switching control circuit, configured to switch an input voltage of the power transistor between the first input voltage and the second input voltage by controlling turn-on and turn-off of the first switching transistor, the second switching transistor and the third switching transistor.

4. The dual-input low-dropout voltage regulating circuit according to claim 3, wherein if a primary power supply is designated as a priority power supply, the power supply switching control circuit is configured to:
in response to the first input voltage becoming lower than a primary power supply stability threshold, switch the input voltage of the power transistor to the second input voltage; and
in response to the primary power supply first input voltage becoming higher than the primary power supply stability threshold, switch the input voltage of the power transistor to the first input voltage,
wherein the first input voltage is received from the primary power supply.

5. The dual-input low-dropout voltage regulating circuit according to claim 4, wherein the power supply switching control circuit is configured to:
generate a first switching control signal for controlling the turn-on and turn-off of the first switching transistor, a second switching control signal for controlling the turn-on and turn-off of the second switching transistor and a third switching control signal for controlling the turn-on and turn-off of the third switching transistor, based on a primary power supply priority indication signal for indicating whether the primary power supply is designated as the priority power supply and a primary power supply stability indication signal for indicating whether the primary power supply is in a stable state.

6. The dual-input low-dropout voltage regulating circuit according to claim 5, wherein when the primary power supply priority indication signal is active, the power supply switching control circuit is configured to:
in response to the primary power supply stability indication signal changing from a reset logic state to a set logic state, change the first switching control signal from the set logic state to the reset logic state to turn on the first switching transistor, and change both the second switching control signal and the third switching control signal from the reset logic state to the set logic state to turn off the second switching transistor and the third switching transistor respectively; and
in response to the primary power supply stability indication signal changing from the set logic state to the reset logic state, change the first switching control signal from the reset logic state to the set logic state to turn off the first switching transistor, and change the second switching control signal and the third switching control signal from the set logic state to the reset logic state to turn on the second switching transistor and the third switching transistor respectively.

7. The dual-input low-dropout voltage regulating circuit according to claim 3, wherein if a primary power supply is not designated as a priority power supply, the power supply switching control circuit is configured to:
in response to the first input voltage becoming higher than the second input voltage, switch the input voltage of the power transistor to the first input voltage; and
in response to the first input voltage becoming lower than the second input voltage, switch the input voltage of the power transistor to the second input voltage,
wherein the first input voltage is received from the primary power supply.

8. The dual-input low-dropout voltage regulating circuit according to claim 7, wherein the power supply switching control circuit is configured to: generate a first switching control signal for controlling the turn-on and turn-off of the first switching transistor, a second switching control signal for controlling the turn-on and turn-off of the second switching transistor, and a third switching control signal for controlling the turn-on and turn-off of the third switching transistor, based on a primary power supply priority indication signal for indicating whether the primary power supply is designated as the priority power supply, the first input voltage and the second input voltage.

9. The dual-input low-dropout voltage regulating circuit according to claim 8, wherein when the primary power supply priority indication signal is inactive, the switching control signal generating circuit is configured to:
in response to the first input voltage becoming higher than the second input voltage, change the first switching control signal from a set logic state to a reset logic state to turn on the first switching transistor, and change both the second switching control signal and the third switching control signal from the reset logic state to the set logic state to turn off the second switching transistor and the third switching transistor respectively; and
in response to the first input voltage becoming lower than the second input voltage, change the first switching control signal from the reset logic state to the set logic state to turn off the first switching transistor, and change both the second switching control signal and the third switching control signal from the set logic state to the reset logic state to turn on the second switching transistor and the third switching transistor respectively.

10. The dual-input low-dropout voltage regulating circuit according to claim 7, wherein the power supply switching control circuit is configured to:
in response to the first input voltage becoming higher than the second input voltage, turn on the first switching transistor and turn off the second switching transistor, and turn off the third switching transistor after a delay period following turning on the first switching transistor and turning off the second switching transistor, to switch the input voltage of the power transistor to the first input voltage; and
in response to the first input voltage becoming lower than the second input voltage, turn off the first switching transistor and turn on the second switching transistor to switch the input voltage of the power transistor to the second input voltage, wherein the third switching transistor is turned on in advance by an advance period before turning off the first switching transistor and turning on the second switching transistor.

11. The dual-input low-dropout voltage regulating circuit according to claim 7, wherein the power supply switching control circuit is configured to: generate a first switching control signal for controlling the turn-on and turn-off of the first switching transistor, a second switching control signal for controlling the turn-on and turn-off of the second switching transistor, and a third switching control signal for controlling the turn-on and turn-off of the third switching transistor, based on a primary power supply priority indication signal for indicating whether the primary power supply is designated as the priority power supply, a primary power supply stability indication signal for indicating whether the primary power supply is in a stable state, the first input voltage, and the second input voltage.

12. The dual-input low-dropout voltage regulating circuit according to claim 11, wherein when the primary power supply priority indication signal is inactive, the switching control signal generating circuit is configured to:
change the first switching control signal from a set logic state to a reset logic state to turn on the first switching transistor, and change the second switching control signal from the reset logic state to the set logic state to turn off the second switching transistor in response to the first input voltage becoming higher than the second input voltage, and change the third switching control signal from the reset logic state to the set logic state to turn off the third switching transistor in response to the primary power supply stability indication signal changing from the reset logic state to the set logic state; and
change the third switching control signal from the set logic state to the reset logic state to turn on the third switching transistor in response to the primary power supply stability indication signal changing from the set logic state to the reset logic state, and change the first switching control signal from the reset logic state to the set logic state to turn off the first switching transistor and change the second switching control signal from the set logic state to the reset logic state to turn on the second switching transistor in response to the first input voltage becoming lower than the second input voltage.

13. The dual-input low-dropout voltage regulating circuit according to claim 5, wherein the power supply switching control circuit comprises a register for storing information indicating whether the primary power supply priority indication signal is active or not.

14. The dual-input low-dropout voltage regulating circuit according to claim 5, wherein the power supply switching control circuit further comprises a primary power supply state determination circuit, configured to determine whether the primary power supply is in the stable state.

15. The dual-input low-dropout voltage regulating circuit according to claim 14, wherein the primary power supply state determination circuit is configured to determine that the primary power supply is in the stable state when the first input voltage is higher than the primary power supply stability threshold; and determine that the primary power supply is not in the stable state when the first input voltage is lower than the primary power supply stability threshold.

16. A power management chip, comprising a dual-input low-dropout voltage regulating circuit, wherein the dual-input low-dropout voltage regulating circuit comprises:
a first input terminal, configured to receive a first input voltage;
a second input terminal, configured to receive a second input voltage;
a power transistor, configured to convert at least one of the first input voltage and the second input voltage to an output voltage; and
a switching circuit, comprising a first switching transistor coupled between the first input terminal and the power transistor, and a second switching transistor and a third switching transistor coupled between the second input terminal and the power transistor,
wherein, a body diode of the second switching transistor and a body diode of the third switching transistor are coupled in series in a back-to-back manner.
